(19) United States
(12) Patent Application Publication
(10) Pub. No.: US 2003/0028742 A1
(43) Pub. Date: Feb. 6, 2003

(54) METHOD FOR SECURING A TYPED DATA LANGUAGE, PARTICULARLY IN AN EMBEDDED SYSTEM, AND EMBEDDED SYSTEM FOR IMPLEMENTING THE METHOD

(76) Inventors: Patrice Hameau, Boulogne Billancourt (FR); Nicolas Fougeroux, Le Chesnay (FR); Olivier Landier, Paris (FR)

Correspondence Address: Miles & Stockbridge, Suite 500, 1751 Pinnacle Drive, McLean, VA, 22102-3833, US

(21) Appl. No.: 10/031,226

(22) PCT Filed: May 17, 2001
(86) PCT No.: PCT/FR01/01506

(30) Foreign Application Priority Data
May 17, 2000 (FR) 00/06882

(51) Int. Cl. G06F 12/00

(52) U.S. Cl. 711/172

(57) ABSTRACT

The invention concerns a method and an embedded microchip system (8) for the secure execution of an instruction sequence of a computer application in the form of typed objects or data, particularly written in “Java” language. The memory (1) is organized into a first series of elementary stacks (2, 3) for storing instructions. Each typed object or datum is associated with one or more so-called typing bits specifying the type. These bits are stored in a second series of elementary stacks (4, 5) that correspond one-to-one with with the stacks (2, 3) of the first series. Before executing predetermined types of instructions, a continuous verification is performed, prior to the execution of these instructions, of the matching between a type indicated by the latter and an expected type, indicated by the typing bits. If they do not match, the execution is stopped.

The invention relates to a method for dynamically securing a typed data language, particularly for an embedded microchip system.

The invention also relates to an embedded microchip system for implementing the method.

Within the context of the invention, the term “embedded system” should be understood in its most general sense. It particularly concerns all kinds of low-power terminals equipped with a microchip, and more particularly smart cards per se. The microchip is equipped with storage means and digital data processing means, for example a microprocessor for the latter means.

To illustrate the concept without in any way limiting the scope of the invention, hereinafter we will stay within the context of the preferred application of the invention, i.e. smart-card based applications, unless otherwise indicated.

Likewise, although there are various computer languages, like the languages “ADA” or “KAMEL” (both being registered trademarks), of the type known as typed data or object languages, since one of the most commonly used languages in the preferred field of the invention is the “Java” (registered trademark) object language, this language will be used hereinafter as an example to describe the method of the invention in detail.

Lastly, the term “securing” should also be understood in a general sense. In particular, it concerns anything related to the concept of confidentiality for the data manipulated, and to the concept of integrity for the hardware and/or software components present in the embedded system.

Before describing the invention in greater detail, it is first useful to briefly review the main characteristics of the “Java” language, particularly in a smart card type environment.

This language specifically has the advantage of being multi-platform; the machine in which the application written in “Java” language is executed need only be equipped with a minimum number of specific computer resources, including a piece of software called a “Java virtual machine” for interpreting a stream of 8-bit “p-code” instruction sequences, called “bytecode” or “p-code” (for “program code”). The “p-code” is stored in storage positions of the aforementioned data storage means. More precisely, in the case of the “Java” language, the area occupied by the storage positions, from a logical point of view, is in a configuration known as a stack.

In the case of a smart card, the latter incorporates the “Java virtual machine” (stored in its storage means) and works by interpreting a language based on the aforementioned opcode sequence. The executable code or “p-code” results from a pre-compilation. The compiler is configured so that the transformed language obeys a given format and complies with a certain number of rules established a priori.

The “opcodes” can receive element values that follow them in a sequence of the “p-code”; these elements are called parameters. The opcodes can also receive values from the stack. These elements constitute operands.

According to another characteristic of the “Java” language, elements known as “classes” and “methods” are used. During the execution of a given method, the virtual machine retrieves the corresponding “p-code.” This “p-code” identifies specific operations to be executed by the virtual machine. A particular stack is necessary for processing so-called local variables, for arithmetic operations or for invoking other methods.

This stack serves as a working area for the virtual machine. In order to optimize the performance of the virtual machine, the length of the stack is generally fixed for a given primitive type.

In this stack, two main types of objects can be manipulated:

objects of the so-called “primitive” type, known by the denominations “int” (for long integer: 4 bytes), “short” (for short integer: 2 bytes), “byte” (byte), “boolean” (boolean object); and

objects of the so-called “reference” type (arrays of primitive type objects, instances of classes).

The fundamental difference between these two types of objects is that only the virtual machine assigns a value to reference type objects and manipulates them.

The reference objects may be seen as pointers to storage areas of the smart card (physical or logical references).

The “Java” language, whose main characteristics have been briefly summarized, is particularly well suited to applications that involve interconnections with the Internet, and its great success is linked to the widespread development of Internet applications.

From the point of view of security, it also has a certain number of advantages. First of all, the executable code or “p-code” results from a pre-compilation. The compiler can therefore be configured, as indicated above, so that the transformed language obeys a given format and complies with a certain number of rules established a priori.

One of these rules is that a given application be confined in what is called a “sand box” (or in French, a “black box”). The instructions and/or data associated with a given application are stored in storage positions of the data storage means. In the case of the “Java” language, from a logical point of view, the configuration of these data storage means takes the form of a stack. Confinement in a “sand box” means that, in practice, the aforementioned instructions cannot address storage positions outside those assigned to said application, without being expressly authorized to do so.

However, once loaded into memory, security problems can arise if the “p-code” has been altered or if its format does not conform to the specifications of the virtual machine. Also, in the prior art, particularly when it involves applications, for example “applets,” downloaded via the Internet, the compiled code, i.e. the “p-code,” is verified by the virtual machine. The latter is normally associated with a “web” browser with which the terminal connected to the Internet is equipped. For this purpose, the virtual machine is itself associated with a particular piece of software, or verifier.

This verification can be done in the so-called “off-line,” i.e. disconnected, mode, which does not penalize the running of the application, particularly from the point of view of communication costs.

Thus, one can be sure that after the verification has been performed, the “p-code” is not damaged and complies with the pre-established format and rules. One can also be sure, under these conditions, that during the execution of the “p-code”, there will not be any deterioration of the terminal in which it is executed.

However, this method is not without its drawbacks, particularly within the context of the applications preferably envisaged by the invention.

First of all, the aforementioned verifier alone requires a relatively large amount of memory, on the order of several MB. This high value does not pose any particular problem if the verifier is stored in a microcomputer or a similar terminal having substantial memory resources. However, when planning to use a data processing terminal having more limited computing resources, a fortiori a smart card, it is not possible from a practical point of view, given the technologies currently available, to implement the verifier in this type of terminal.

It should also be noted that the verification is of a type that may be qualified as “static”, since it is performed only once, prior to the execution of the “p-code”. When the terminal is of the microcomputer type, especially when the latter remains offline during the execution of the pre-verified “p-code,” this last characteristic does not pose any particular problems. In fact, there are no substantial risks from a security point of view, since the terminal normally remains under the control of its operator.

This is not the case for a mobile embedded system, especially for a smart card. In fact, if the “p-code”, even if it is verified, is then loaded into the data storage means of the smart card it can be subject a posteriori to alterations. In general, the smart card, by nature, is not designed to remain permanently in the terminal from which the application has been loaded. To give a nonlimiting example, the smart card may be subjected to an ionizing radiation that physically alters the storage positions. It is also possible to alter the “p-code” as it is downloaded into the smart card from the terminal.

It follows that if the “p-code” is altered, particularly for malicious purposes, it is possible to perform a so-called “dump” (duplication) of the storage areas and/or to endanger the proper functioning of the smart card. It thus becomes possible, for example, despite the presence of the aforementioned “sand box,” to access confidential, or at least unauthorized, data or to attack the integrity of one or more applications present in the smart card. Finally, if the smart card is connected to the outside world, the resulting abnormal operations can be propagated outside the smart card.

The object of the invention is to eliminate the drawbacks of the methods and devices of the prior art, some of which have just been summarized.

The object of the invention is to provide a method for dynamically securing applications in a typed data language in an embedded system.

Another object is to provide a system for implementing this method.

To this end, according to a first characteristic, a binary information element comprising one or more bits, which will hereinafter be called a “type information element,” is associated with each object manipulated by the virtual machine, in this case in the aforementioned “Java” language. More generally, a type information element is associated with each piece of typed data manipulated in a given typed data or object language.

According to another characteristic, the type information elements are physically stored in specific storage areas of the storage means of the embedded microchip system.

According to yet another characteristic, the virtual machine, again in the case of the “Java” language, verifies said type information elements during certain operations in the execution of the “p-code”, such as the manipulation of objects in the stack, etc., which operations are specified below. Also, more generally, for another language, the process is similar and involves a step for verifying the type information elements. It is noted that, advantageously, said verification is of a type that may be called dynamic, since it is performed in real time during the interpretation or execution of the code.

The virtual machine, or its equivalent for a language other than the “Java” language, continuously verifies, prior to said execution of an instruction or an operation, that the type information element actually corresponds to the expected type of the typed object or data to be manipulated. When an incorrect type is detected, security measures are taken in order to protect the virtual machine and/or prevent any operations that are illegal and/or dangerous for the integrity of the embedded microchip system.

According to a first additional variant of the method according to the invention, said type information elements are also advantageously used to manage stacks of variable width, which makes it possible to optimize the storage space of the embedded microchip system, wherein the resources of this type are naturally limited, as mentioned above.

According to a second additional variant, which may exist concurrently with the first one, the type information elements are also used, with one or more additional information bit(s) used as “flags” added to them, to mark the typed objects or data. This marking is then used to indicate whether or not the latter elements are used, and if not, whether they can be erased from the memory, which also makes it possible to gain storage space.

Hence, the main subject of the invention is a method for the secure execution of an instruction sequence of a computer application in the form of typed data stored in a first series of given locations in a memory of a computer system, particularly an embedded microchip system, characterized in that additional data called type information elements are associated with each of said typed data, in order to specify the type of these data, in that said type information elements are stored in a second series of given storage locations in said memory of a computer system, and in that before the execution of instructions of a predetermined type, a continuous verification is performed, prior to the execution of predetermined instructions, of the matching between a type indicated by these instructions and an expected type indicated by said type information elements stored in said second series of storage locations, so that said execution is authorized only when there is match between said types.

Another subject of the invention is an embedded microchip system for implementing this method.

The invention will now be described in greater detail in reference to the attached drawings, in which:

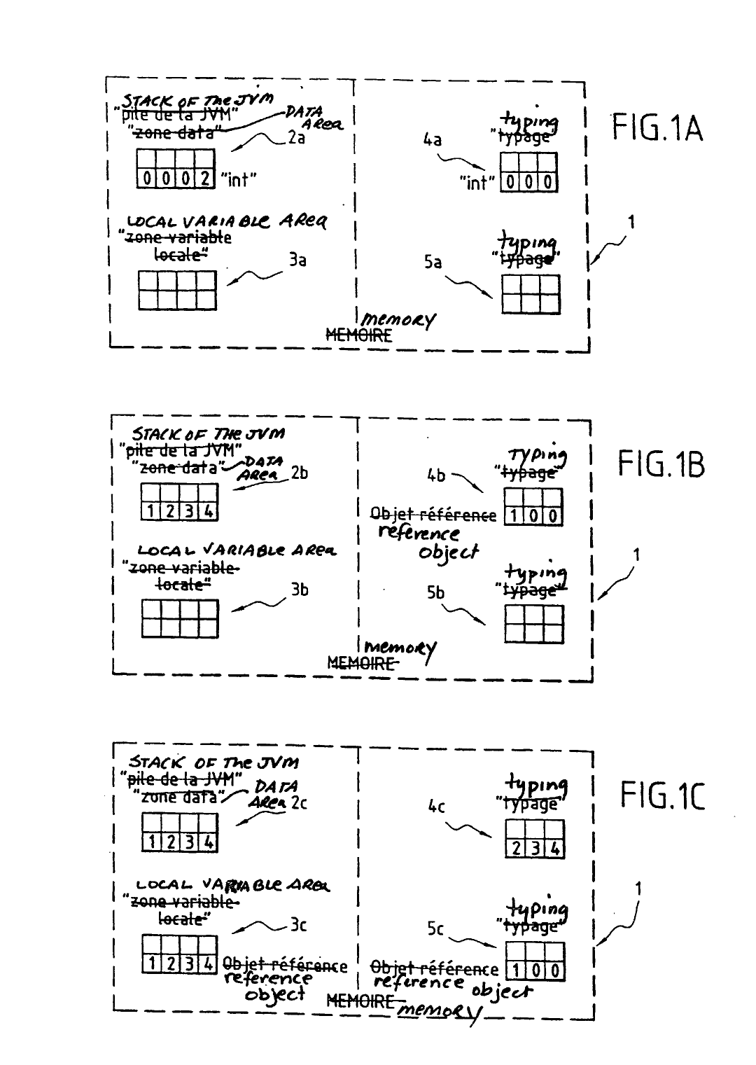

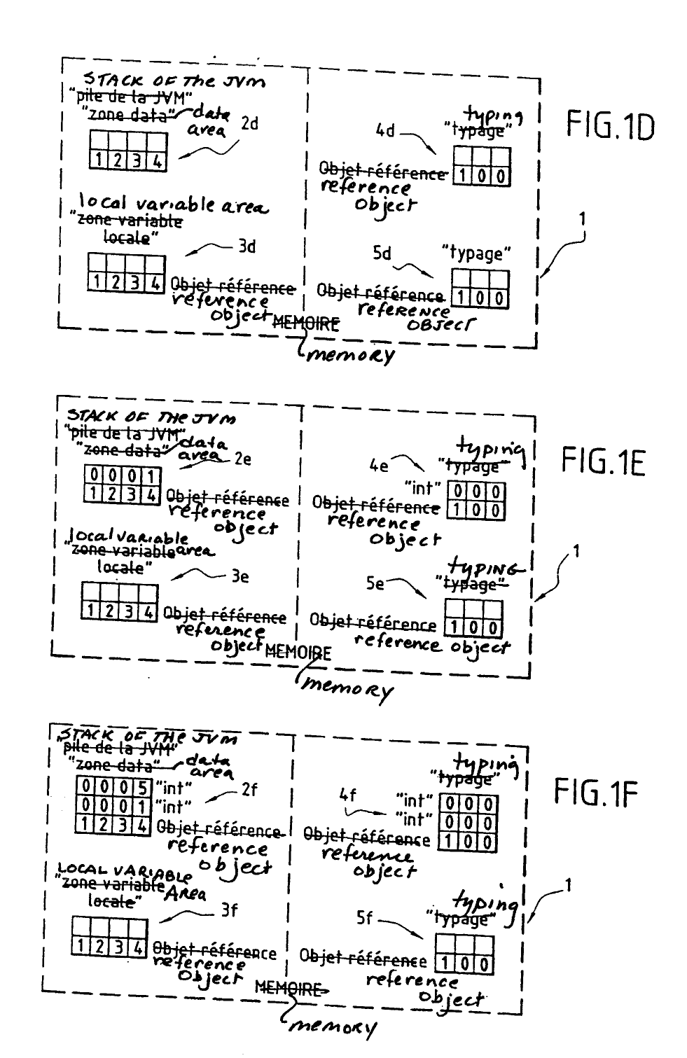

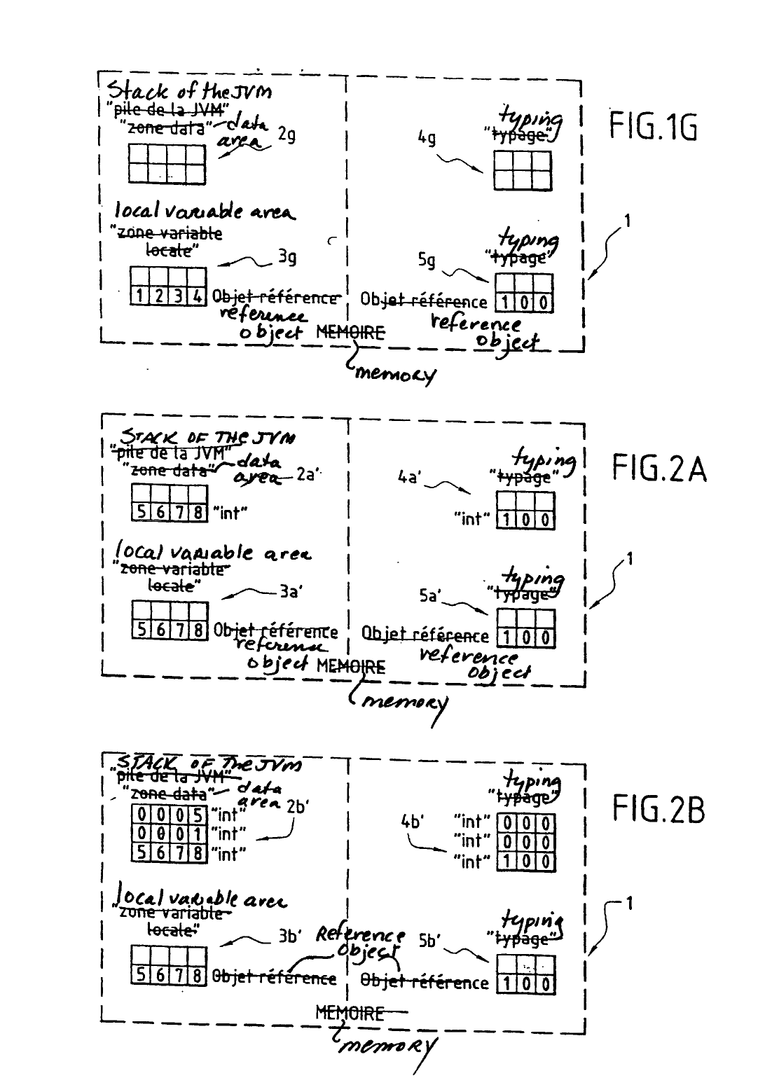

FIGS. 1A through 1G illustrate the main steps of a correct execution of an exemplary “p-code” in a stack memory associated with specific storage areas storing data called type information elements according to the invention;

FIGS. 2A and 2B schematically illustrate steps in the execution of this same code, but containing an alteration resulting in an incorrect execution and a detection of this alteration by the method of the invention; and

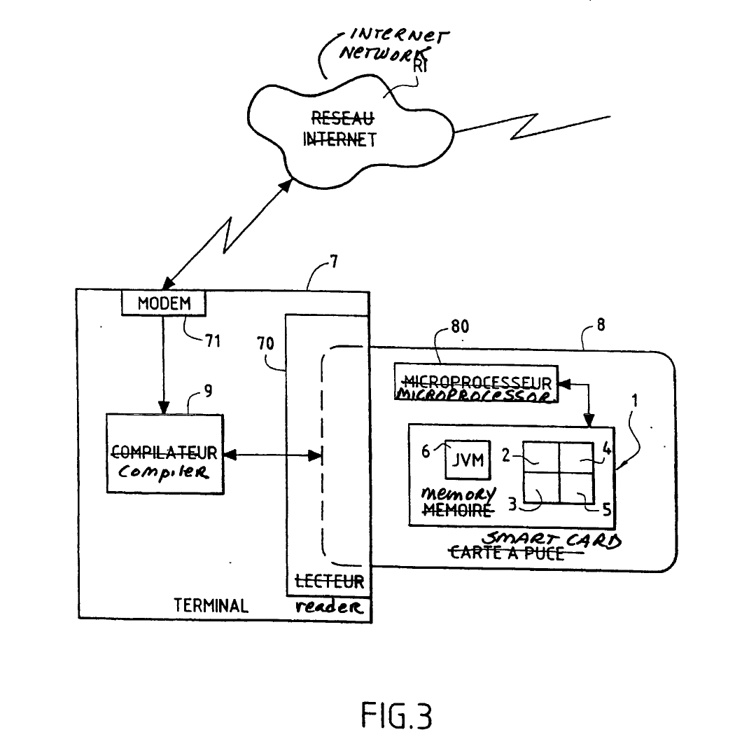

FIG. 3 schematically illustrates a system comprising a smart card for implementing the method according to the invention.

Hereinafter, without in any way limiting the scope of the invention, we will stay within the context of the preferred application of the invention, unless otherwise indicated, i.e., within the case of an embedded microchip system that incorporates a “Java” virtual machine for interpreting “p-code.”

As indicated in the preamble of the present specification, during the execution of a given method, the virtual machine retrieves the corresponding “p-code.” This “p-code” identifies specific operations to be executed by the virtual machine. A particular stack is necessary for processing so-called local variables, for arithmetic operations or for invoking other methods.

This stack serves as a working area for the virtual machine. In order to optimize the performance of the virtual machine, the length of the stack is generally fixed for a given primitive type.

Also as indicated above, in this stack two main types of objects can be manipulated:

objects of the so-called “primitive” type, known by the denominations “int” (for long integer: 4 bytes), “short” (for short integer: 2 bytes), “byte” (byte), “boolean” (boolean object); and

objects of the so-called “reference” type (arrays of primitive type objects, instances of classes).

It is objects of the latter type that pose the greatest problem from a security point of view, since there are ways, as indicated above, to manipulate them artificially and thus create abnormal operations of various types.

There are several types of “opcodes”, including:

the creation of a primitive type object (for example the opcodes named “bipush” or “iconst”);

the execution of arithmetic operations on primitive type objects (for example the “opcodes” named “iadd” or “sadd”);

the creation of a reference object (for example the “opcodes” named “new”, “newarray” or “anewarray”).

the management of local variables (for example the “opcodes” named “aload”, “iload” or “istore”); and

the management of class variables (for example the “opcodes” named “getstatic_a” or “putfield_i”).

Each “opcode” that uses objects placed in a stack is typed in order to guarantee that its execution can be controlled. Generally, the first letter(s) of the “opcodes” indicate(s) the type used. For example, to illustrate the concept, (the first letter(s) being indicated in boldface to emphasize this situation), the following “opcodes” may be mentioned:

“aload” for the referenced objects;

“iload” for the integers; and

“iload” for the integer arrays.

Hereinafter, for purposes of simplification, the “Java virtual machine” will be called JVM.

According to a first characteristic of the method according to the invention, type information elements are stored in a storage area, each in the form of one or more bits. Each of these type information elements characterizes an object manipulated by the JVM. A type information element is specifically associated with:

each stacked object in the data area of the stack;

each local variable (a variable whose scope does not extend beyond the environment of a method); and

each object in what is called the “heap”, i.e., a storage area storing the so-called “reference” objects, each array, and each global variable.

This operation may be called the “typing” of the objects. According to a second characteristic of the method of the invention, the JVM verifies the typing in the following cases:

when an “opcode” manipulates an object stored in the stack;

retrieves an object in the area of the “heap” or in that of the local variables in order to place it in the stack;

modifies an object in the area of the “heap” or in that of the local variables; and

during the invocation of a new method, when the operands are compared to the signature of the method.

According to another characteristic of the method of the invention, the JVM verifies, before the execution of the above operations, that their types actually match the expected types (i.e., those given by the “opcode” to be executed).

If an incorrect type is detected, security measures are taken in order to protect the JVM and/or to prevent any operations that are illegal or dangerous for the integrity of the system, from either a logical or a hardware point of view.

In order to better explain the method according to the invention, we will now describe it in detail by considering a particular example of source code in “Java” language.

We will also assume that the JVM is associated with a 32-bit stack comprising no more than 32 levels and supporting the primitive types (for example “int”, “short”, “byte”, “boolean” and “object reference”)

The typing of the stack, according to one of the characteristics of the invention, can be performed using type information elements that are 3 bits long, in accordance with TABLE I located at the end of the present specification. The values indicated in TABLE I are naturally arbitrary. Other conventions could be used without going beyond the scope of the invention.

The “Java” source code that will be considered below as a particular example is the following:

Java” Source (1):

Public void method( ){

int[] buffer; //Declaration

buffer=new int[2]; //creation of an integer array with 2 elements

buffer[1]=5; //initialization of the array with the value 5

}

After passing through an appropriate compiler, a “class” file containing the “p-code” (2) corresponding to the above source code (1) is obtained. It appears as follows:

“p-code” (2):

iconst_{—}2 //Push int constant 2

newarray T_INT

astore_{—}1 int[] buffer;

aload_{—}1 int[] buffer;

iconst_{—}1 //Push int constant 1

iconst_{—}5 //Push int constant 5

iastore

return

As is well known to one skilled in the art, the first three lines correspond to the creation of the aforementioned array (see source code (1)). The last five lines correspond to the initialization of this array.

We will now illustrate in detail the steps of a correct execution of the above “p-code.” Since “p-code” is an interpreted language, the successive lines are read one after the other and the aforementioned steps correspond to the execution of these lines, possibly with the execution of iterations and/or jumps. Hereinafter, the various lines of code are indicated in boldface in order to emphasize them.

Correct execution:

Step 1: “iconst_{—}2”

FIG. 1A schematically illustrates the step for executing this “p-code”. The reference 1 is used to represent the memory of the embedded microchip system (not represented). More precisely, this memory 1 is divided into four main parts, two of which are common to the prior art: the area called the “data area” 2a and the area called the “local variable area” 3a. These areas, 2a et 3a, constitute the stack per se of the “Java” virtual machine (JVM) which for purposes of simplification will hereinafter be called the “stack of the JVM”.

Associated with these areas are storage areas, respectively 4a et 5a, specific to the invention, which will hereinafter be called “Typing” areas. According to one of the aspects of the invention, the storage areas 4a et 5a, are designed to store type information elements (3 bits long in the example described) associated with the data stored in the areas 2a et 3a, respectively, in storage locations that correspond one-to-one with the storage locations of these areas. The logical organization of these storage areas is the type known as a “stack,” as mentioned. Also, they are represented in the form of arrays with the dimensions c×l, with c being the number of columns and l being the number of lines, i.e., the “height” or level of the stack (which can vary with each step in the execution of a “p-code”). In the example, c=4 for the “data area” 2a et the “local variable area” 3a (each column corresponding to a storage position of 4 bytes, or 32 bits in total), and c=3 for the “typing” areas, 4a et 5a, (each column corresponding to a 1-bit storage position). In FIG. 1A, the number of lines represented (or level number: 1 to 32 maximum in the example described) is equal to 2 for all of the storage areas. Each of the storage areas, 2a á 5a, therefore constitutes an elementary stack.

It should be understood, however, that physically, the aforementioned storage positions can be produced based on various electronic circuits: RAM storage cells, registers, etc. Likewise, they are not necessarily contiguous in the memory space 1. FIG. 1A constitutes only a schematic representation of the logical organization of the memory 1 into stacks.

The “opcode” to be executed during this first step has no parameters, and no operands. The integer value 2 (or “0002”) is placed in the stack at level 1 (the bottom line in the example) of the area 2a. The corresponding “Typing” area 4a is updated.

In keeping with the conventions of TABLE I, the value “int” (integer) “000” (in bits is placed in the “Typing” area 4a, also at level 1 (bottom line). No value is placed in the “local variable area” 3a. The same goes for the corresponding “Typing” area 5a.

Step 2: newarray T_INT

The corresponding step is illustrated by FIG. 1B.

The elements common to FIG. 1A have the same numeric references and will be described again only as necessary. Only the letter value associated with the numeric values is changed. It is identical to that in the corresponding figure, or b in the case of FIG. 1B, so as to characterize the successive modifications of the contents of the storage areas. The same goes for the subsequent FIGS. 1C á 1G.

The “opcode” to be executed during this second step has as a parameter the type of array to be created (i.e., the type “int”).

This “opcode” has as an operand a value that must be of the “int” type, corresponding to the size of the array to be created (i.e. 2).

The verification of the “Typing” area (in state 4a) indicates a correct type. The execution is therefore possible.

A reference object is created in the “JVM Stack”: for example the (arbitrary) four byte value “1234” is placed in the storage positions of the “local variable area” (level 1). Since it is a reference type object, the value “100” (in bits) is placed in the corresponding “Typing” area 5b (level 1).

No value is placed in the storage area 3b, or in the “Typing” area 5b.

Step 3: astore_{—}1 int[] buffer

This step is illustrated by FIG. 1C.

The “opcode” has as an operand a value that must be of the “Reference object” type. The verification of the “Typing” area (in state 4a) indicates a correct type. The execution is therefore possible.

The reference object is moved to the “local variable area” 3c: location 1 (level 1).

The “Typing” areas 4c et 5c are updated: the value “100” (in bits) is moved from level 1 of the area 4c to level 1 of the area 5c.

Step 4: aload_{—}1 int[] buffer

This step is illustrated by FIG. 1D.

The purpose of this “opcode” is to push the reference object “1234”, stored in the “local variable area” 3d, to level 1 of the “data area” 2d, i.e., into the storage positions on the bottom line of this area.

The verification of the “Typing” area (in state 5c) indicates a correct type. The execution is therefore possible.

The reference object “1234” is placed in the “data area” 2d.

The “Typing” areas 4d et 5d are updated, and both of them store, in the corresponding storage locations, the value “100” (in bits), representing a “reference object” type.

Step 5: iconst_{—}1 //Push int constant 1

This step is illustrated by FIG. 1E.

The “opcode” to be executed during this step has no parameters, and no operands. The integer value 1 (or “0001 ”) is placed in the stack: location 2 (level 2) of the “data area” 2e. The corresponding “Typing” area 4e is updated, also on level 2 (level 1 remains unchanged: value “1000”). The “int” (integer) value “000” (in bits) is placed in the “Typing” area 4e (level 2). The areas 3e and 5e remain unchanged.

Step 6: iconst_{—}5 //Push int constant 5

This step is illustrated by FIG. 1F.

The “opcode” to be executed during this step has no parameters, and no operands. The integer value 1 (or “0001”) is placed in the stack: level 3 of the “data area” 2f. The corresponding “Typing” area 4f is updated, also on level 3 (levels 1 and 2 remain unchanged: the values “1000” and “000” respectively). The “int” (integer) value “000” (in bits) is placed in the “Typing” area 4f. The areas 3f and 5f remain unchanged.

Step 7: iastore

This step is illustrated by FIG. 1G.

This “opcode” has as an operand a value of the “int” type, an index of the “int” type and a reference object of the array type.

The verification of the “Typing” area (in state 4f: level 3) indicates a correct type. The execution is therefore possible.

The value is stored in the reference object with the given index.

Step 7: return

This “opcode” indicates the end of the method; the stack should therefore be empty.

Again considering the same “p-code” (see (2), obtained after compiling the source code (1)), we will now describe in detail an example of an incorrect execution.

Incorrect execution:

In the step we will call 4′ (which corresponds to step 4: FIG. 1D), it is assumed that the “p-code” has been altered and that the “opcode”

“aload_{—}1 int[] buffer”

has been replaced, for example by the following “opcode”:

“iipush 0×5678”,

in which instruction “0×” indicates a hexadecimal value.

As illustrated in FIG. 2A, the purpose of this “opcode” of the reference object type, stored on level 1 of the “local variable area” 3a′, is to push an integer value “5678” into the stack, in the “data area” 2′a.

The corresponding “Typing” area 4a′ is updated. It follows that the levels 1 of the “Typing” areas 4d et 5a′ will both contain the value “100” (in bits), i.e., a value associated with a “Reference object”. This particular configuration is illustrated by FIG. 2A.

The execution proceeds normally as in the preceding case illustrated in reference to FIGS. 1E and 1F.

Step 5′: iconst_{—}1 //Push int constant 1

Step 6′: iconst_{—}5 //Push int constant 5

The state of the areas of the “stack of the JVM”, the “local variable area” 3b′ and the “data area” 2b′, is illustrated by FIG. 2B. More precisely, the “data area” 2b′ stores, on level 1, the integer value “5678”, on level 2, the integer value “0001 ” and on level 3, the integer value “0005”. The “local variable area” 3a′ remains unchanged. The same goes for the corresponding “Typing” area 5a′. On the other hand, the “Typing” area 4b′ is updated, and the following values are stored on the respective levels 1 through 3: “100”, “000” and “000” (in bits).

Step 7′: iastore

This “opcode” has as an operand a value of the “int” type, an index of the “int” type and a reference object of the array type.

The verification of the “Typing” area (level 1 of the area, in state 4b′) indicates that the code detected is incorrect In essence, an integer (“int”; code “000”) was expected instead of a “reference object” (code “100”).

The JVM has therefore detected the presence of an illegal “opcode” that threatens the security of the system. The normal execution of the current instruction sequence is interrupted and replaced by the execution of instructions corresponding to pre-programmed security measures: a warning signal, etc.

It has been assumed up to this point that the width (or size) of the “stack of the JVM,” no matter what the size of the “data area” or the “local variable area”, is fixed, which is generally the case in the prior art. In the example described, it has been assumed that each storage location contains four bytes (or 32 bits). However, an arrangement of this type is detrimental in terms of storage capacity. In fact, from one software application to another, or even within the same application, the number of bytes required for each instruction is variable. As indicated above, the arrangement of the elementary stacks of the “data area” et “local variable area,” as illustrated in FIGS. 1A through 1G or 2A through 2B, represents only a logical view of the memory space 1. It is therefore entirely possible to retain an architecture of the stack type, even if the storage locations, which may or may not be successive, are of variable length, or even if the various storage positions (cells) are physically scattered.

Also, according to a first additional variant of the method according to the invention, the type information elements also make it possible to determine the current width required, in storage positions, in the areas of the “stack of the JVM”. To do this, the codes stored in the “Typing” areas of the memory need only be associated, as a whole or in part, with a piece of information that characterizes the width of the aforementioned stack. To give a nonlimiting example, it could be additional bits, added to the typing codes, or a combination of unused bits of these codes. In the first case, if the width of the stack can vary, again to give an example, from 1 to 4 octets, 2 additional bits would be enough to characterize the following widths:

Binary configuration

| | 00 | 01 | 10 | 11 |
|---|---|---|---|---|
| Width in bytes | 1 | 2 | 3 | 4 |

This arrangement, which makes it possible to optimize the memory space based on the applications to be executed, results in a substantial gain in storage space, which constitutes an appreciable advantage in the case of devices, such as a smart card in particular, wherein the storage resources are naturally limited.

According to a second variant of embodiment of the method according to the invention, it is also possible to use the type information elements to indicate whether an object is still being used (i.e., should be saved) or whether it can be erased from the “local variable area”. In essence, at the end of a certain number of operations, a given object stored in this area is no longer used. Leaving it permanently stored therefore constitutes a needless waste of storage space.

To give a nonlimiting example, it is possible to add an information bit to the codes stored in the “Typing” areas, which serves as a “flag.” The state of this bit indicates whether the object should be saved (since it is still being used) or can be erased, and marks it accordingly. The following arbitrary conventions can be adopted:

logical state “0”=object used

logical state “1”=object can be erased

This provision, which may be qualified as a mechanism of the “garbage collector” type, also allows a gain in storage space.

Naturally, the provisions specific to both additional variants of embodiment just described can exist concurrently.

FIG. 3 schematically illustrates an exemplary architecture of a smart card application based computer system for implementing the method according to the invention described above.

This system comprises a terminal 7, which may or may not be linked to external networks, including the Internet RI, by a modem or any equivalent means 71. The terminal 7, for example a microcomputer, specifically includes a compiler 9. The code can be compiled outside the terminal to produce a so-called “Class” file (“Java” to “Class” compiler), which file is downloaded by an Internet browser, the microcomputer itself including a converter that produces a so-called “Cap” file (“Class” to “Cap”). This converter specifically reduces the size of the “Class” file to make it possible to load it into a smart card. Any application, for example downloaded via the Internet RI and written in “Java” language, is compiled by the compiler 9 and loaded via a smart card reader 70 into the memory circuits 1 of the smart card 8. The latter, as mentioned above, incorporates a “Java” virtual machine (JVM) 6 capable of interpreting the “p-code” resulting from the compilation and loaded into the memory 1. Various memory stacks are also represented: the areas “data area” 2 and “local variable area” 3, as well as the typing areas 4 et 5, the latter being specific to the invention. The smart card 8 also includes conventional data processing means linked to the memory 1, for example a microprocessor 80.

The communications between the smart card 8 and the terminal 7 via the reader 70, and between the terminal 7 and the outside world, for example the Internet RI, via the modem 71, also take place in an intrinsically conventional way, and there is no need to describe them further.

Through the reading of the above, it is easy to see that the invention achieves the stated objects.

It allows the secure execution of a stream of instructions of an application written in a typed data language executed in a memory with a stack type architecture. The high degree of security obtained is specifically due to the fact that the verification of the code is performed dynamically, according to one of the aspects of the invention.

This provision also makes it possible, at the price of a minimal increase in processing time, to eliminate the need for a verifier requiring substantial memory resources. This type of verifier is unsuitable, in practice, for the preferred applications of the invention.

It should be clear, however, that the invention is not limited to just the exemplary embodiments explicitly described, particularly in relation to FIGS. 1A-1G, 2A-2B and 3.

Likewise, although the invention applies more particularly to an object language, and more particularly to the “p-code” of the “Java” language obtained after compilation, it applies to a large number of languages using typed data, such as the “ADA” or “KAMEL” languages mentioned in the preamble of the present specification.

Finally, although the invention is particularly advantageous for embedded microchip systems wherein the computer resources, both in terms of data processing and data storage, are limited, particularly for smart cards, it is entirely suitable, a fortiori, for more powerful systems.

TABLE I

| Prefix | Type | Code |
|---|---|---|
| i | “Int” | 000 |
| s | “Short” | 001 |
| b | “Byte” | 010 |
| z | “Boolean” | 011 |
| a | “Reference Object” | 100 |

1. Method for the secure execution of an instruction sequence of a computer application in the form of typed data stored in a first series of given locations in a memory of a computer system, particularly an embedded microchip system, characterized in that additional data called type information elements are associated with each of said typed data, in order to specify the type of these data, in that said type information elements are stored in a second series of given storage locations (4, 5) in said memory (1) of a computer system (8), and in that before the execution of instructions of a predetermined type, a continuous verification is performed, prior to the execution of predetermined instructions, of the matching between a type indicated by these instructions and an expected type indicated by said type information elements stored in said second series of storage locations (4, 5), so that said execution is authorized only when there is match between said types.

2. Method according to claim 1, characterized in that each of said type information elements is constituted by a string of bits stored in storage locations of said second series (4, 5) that correspond one-to-one with storage locations in said first series (2, 3) in which said associated typed data are stored, and the configuration whereof represents one of said types of typed data.

3. Method according to claim 1, characterized in that, said instructions being those of an application written in “Java” (registered trademark) language, said typed data are constituted by typed objects, in that said computer system incorporates a piece of software called a “Java” virtual machine (5) that manipulates said typed objects, in that said storage locations (2-5) in said memory (1) of the computer system (8) being organized into stacks comprising a given maximum number of levels, each level constituting one of said storage locations, said typed objects are stored in at least a first elementary stack called a data area (2) and a second elementary stack called a local variable area (3), and in that said type information elements are distributed into two additional elementary stacks (4, 5) that correspond one-to-one with said first (2) and second (3) elementary stacks, in order to specify the type of said associated objects stored in said data (2) and local variable (3) areas.

4. Method according to claim 1, characterized in that when there is no match, the execution of said instruction sequence is interrupted and replaced by the execution of instructions corresponding to pre-programmed security measures.

5. Method according to claim 3, characterized in that said type information elements are associated with additional information elements that determine the size of said storage locations in said stacks (2, 3) storing said typed objects, in order to make the size of said stacks variable, based on said objects to be manipulated.

6. Method according to claim 3, characterized in that said type information elements are associated with additional information elements called flags, in order to mark said objects that are associated with them and to indicate whether they should be saved in said stacks (2, 3) or can be erased.

7. Embedded smart card system comprising computer data processing means and storage means for the secure execution of an instruction sequence of a computer application in the form of typed data stored in a first series of given locations in a memory of a computer system, characterized in that said storage means (1) comprise a second series of given locations (4, 5) for storing additional data called type information elements, associated with each of said typed data, in order to specify the type of these data, and verification means (6) for continuously verifying, prior to the execution of predetermined instructions, the matching between a type indicated by these instructions and a type indicated by said type information elements, so as to authorize said execution only when there is a match between said types.

8. System according to claim 7, characterized in that, said first series of given locations in said memory (1) of the embedded microchip system (8) being organized into stacks comprising a given maximum number of levels, each level constituting one of said storage locations, said typed data are stored in at least a first elementary stack called a data area (2) and a second elementary stack called a local variable area (3), and in that said second series of storage locations is also organized into elementary stacks (4, 5) that correspond one-to-one with said first (2) and second (3) elementary stacks.

9. System according to claim 8, characterized in that said type information elements stored in said second series of storage locations (4, 5) are associated with additional information elements that determine the size of said storage locations in said stacks (2, 3) storing said typed data.

10. System according to claim 7, characterized in that said embedded system is a smart card (8).
